(19) United States
(12) Patent Application Publication
(10) Pub. No.: US 2026/0167257 A1
(43) Pub. Date: Jun. 18, 2026

(54) PLANETARY ROLLER GEARING, METHOD FOR PRODUCING A PLANETARY ROLLER GEARING, AND STEERING ACTUATOR

(71) Applicant: Schaeffler Technologies AG & Co. KG, Herzogenaurach (DE)

(72) Inventors: Christoph Radsak, Nürnberg (DE); Simon Merz, Bühl (DE)

(73) Assignee: Schaeffler Technologies AG & Co. KG, Herzogenaurach (DE)

(21) Appl. No.: 19/127,104

(22) PCT Filed: Sep. 18, 2023
(86) PCT No.: PCT/DE2023/100698

§ 371 Date: May 3, 2025

(30) Foreign Application Priority Data
Nov. 4, 2022 (DE) 10 2022 129 139.1

(51) Int. Cl. B62D 5/04; F16H 25/20; F16H 25/24

(52) U.S. Cl. CPC B62D 5/0451; F16H 25/24; F16H 2025/2062

(57) ABSTRACT

The invention relates to a planetary roller gearing (1), in particular for a steering actuator (10), comprising a drive assembly (5) in which a plurality of planets (21, 22, 23) are guided, each planet having a groove-shaped profiled section (24), and a threaded spindle (2) which is provided as an output element and into which central pieces (25) of the planets (21, 22, 23) engage, whereas planet (21, 22, 23) lateral pieces (26) which are likewise profiled in a groove-shaped manner and which are thinner than the central pieces (25) mesh with profiled sections (15) of a nut (11) that is rotatably mounted in the drive assembly (5). The drive assembly (5) has two planet carriers (6) which support the planets (21, 22, 23) and which are rotated relative to each other such that each planet (21, 22, 23) is inclined by a defined angle (a) relative to a straight line which is parallel to the central axis (MA) of the threaded spindle (2) and on which the center of the respective planet (21, 22, 23) lies.

### CROSS-REFERENCE TO RELATED APPLICATIONS

This application is the U.S. National Phase of PCT Application No. PCT/DE2023/100698 filed on Sep. 18, 2023, which claims priority to DE 10 2022 129 139.1 filed on Nov. 4, 2022, the entire disclosures of which are incorporated by reference herein.

### TECHNICAL FIELD

The disclosure relates to a planetary roller gearing suitable for use in an electromechanical actuator. The disclosure further relates to a steering actuator having a planetary roller gearing. Furthermore, the disclosure relates to a method for producing a planetary roller gearing.

### BACKGROUND

A generic planetary roller gearing is known, for example, from DE 10 2021 104 646 A1. The known planetary roller gearing, i.e., a rotary linear gearing, is part of a steering actuator for a rear axle steering system of a motor vehicle. A rotating, drive-side gearing component of the known planetary roller gearing is supported on one side on a first housing component and on the other side on a second housing component of the steering actuator. In the case of DE 10 2021 104 646 A1, a pair of angular contact rolling bearings is provided for mounting the aforementioned gearing component. A threaded spindle acting as the output element of the known steering actuator is guided in a manner secured against rotation and connected to a push rod.

A further planetary roller gearing which has the features of the preamble of claim 1 is disclosed in DE 10 2021 104 649 A1. In this case, too, the planetary roller gearing is a component of a steering actuator intended for use in a rear axle steering system of a motor vehicle. The steering actuator according to DE 10 2021 104 649 A1 has two housing components that form a cavity and are connected to each other by means of a press fit.

Both in the case of DE 10 2021 104 646 A1 and in the case of DE 10 2021 104 649 A1, a planetary roller gearing is provided which is designed as a pitch-accurate planetary screw drive.

The advantage of such a screw drive, also known as an SPWG for short, compared to a planetary roller gearing with a driven spindle nut is that, as the term “pitch-accurate” expresses, a precisely defined relationship exists between the angular position of the driving element and the advance of the driven element, i.e., the threaded spindle. A less extreme transmission ratio compared to planetary screw drives with a driven spindle nut is tolerated in this regard. The terms planetary roller gearing and planetary screw drive are used synonymously.

An actuator disclosed in DE 10 2020 131 828 A1 for a steering device of a motor vehicle also has a planetary screw drive as a gearing, which converts a rotation into a linear movement. The screw drive according to DE 10 2020 131 828 A1 is mounted in a housing by means of a rolling bearing. Rollers of this rolling bearing roll on a resiliently deformable thrust washer.

### SUMMARY

The disclosure is based on the object of further developing a planetary roller gearing which is suitable for use in steering actuators, in particular for a rear axle steering system, compared to the aforementioned prior art, wherein a particularly favorable tribological behavior is sought for a given installation space.

According to the disclosure, this object is achieved by a planetary roller gearing described herein. The embodiments and advantages of the disclosure explained below in connection with the production process also apply analogously to the devices, i.e., the planetary roller gearing and the steering actuator, and vice versa.

With a basic design known per se, the planetary roller gearing comprises a drive assembly in which several elongated planets aligned essentially parallel to the central axis of the gearing are guided. By definition, the drive assembly is formed wholly or in part by a cage guiding the planets. Each planet has sections of different diameters in which groove-shaped, i.e., pitchless, profiled sections are formed. A threaded spindle acts as the displaceable output element of the planetary roller gearing, into the thread of which central pieces, i.e., central groove-shaped profiled sections, of the planets engage, whereas lateral pieces of the planets which are likewise profiled in a groove-shaped manner and have a smaller diameter compared to the central pieces, mesh with profiled sections of a nut, i.e., spindle nut, that is rotatably mounted in the drive assembly.

The drive assembly of the planetary roller gearing according to the disclosure has two planet carriers which support the planets and which are essentially or completely formed in a mirrored manner and which are rotated relative to each other such that each planet is inclined (or angularly mounted) by a defined angle relative to a straight line which is parallel to the central axis of the threaded spindle and on which the center of the respective planet lies. The planet carriers constitute part of the aforementioned cage, which is a drive-side element of the planetary roller gearing. The angle by which the two planet carriers are rotated relative to each other does not generally correspond to the inclination angle of the planets.

The disclosure is based on the consideration that planets of a planetary roller gearing can, in principle, be guided with play in two planet carriers, wherein the two planet carriers can be formed in an essentially disc-shaped manner and arranged parallel to each other. The given play, together with a possible flexibility of the planet carriers, leads to a constraining of the planets, which, depending on the operating conditions, can have a detrimental effect on wear. In addition, the constraining of the planets can lead to the different planets of the gearing being subjected to differing mechanical loads. According to conventional, unclaimed approaches, an attempt could be made to counteract the disadvantages described by guiding the planets in a more precise manner, allowing at most the slightest deviations of the planets from their alignment parallel to the threaded spindle.

The solution according to the disclosure deliberately turns away from such approaches and instead provides for a defined non-parallel arrangement of the planets in relation to the central axis of the threaded spindle and thus of the entire planetary roller gearing. Surprisingly, it is precisely the deviation of the alignment of the essentially rod-shaped planets from an arrangement parallel to the central axis of the entire gearing that contributes to a more uniform contact pattern and thus to significantly reduced wear.

According to an example embodiment, the two planet carriers have receptacles provided for the sliding bearing of non-profiled end pins of the planets, which receptacles are inclined to the same extent as the planets with respect to a plane applied to the respective planet carrier and normal to the central axis. By precisely adapting the receptacles to the inclined position of the central axes of the planets, edge loads on the planet carriers or other load peaks that could lead to material removal on the planet carriers are avoided as far as possible. This is particularly relevant in embodiments in which the planet carriers are made of plastic.

One possible further development is that the receptacles in which the planets are guided on both sides are formed by slide bushings integrated into the planet carriers, which can be displaced to a limited extent in the radial direction thereof. In contrast to the bearing of the slide bushings, which includes a degree of freedom in the radial direction, the receptacles formed within the slide bushings for the end pieces of the planets can be circular, such that the aforementioned degree of freedom is omitted at this point, which is advantageous as far as lubrication is concerned.

Irrespective of the exact design of the receptacles for the planets, the planets are inclined, i.e., constrained, in particular by an angle of at least 0.1° and a maximum of 3.0°, for example by an angle of at least 0.5° and a maximum of 1.0°.

According to various possible embodiments in which there is an even number of planets, for example twelve, the planets can be divided into two equally large subgroups of planets, wherein the following applies to the first subgroup:

$$α = ( {tan}^{- 1} ( P / ( π \cdot D ) ) ) / 2 \pm ( {tan}^{- 1} ( P / ( π \cdot D ) ) ) / 4 + ( {tan}^{- 1} ( P / ( π \cdot D ) ) ) / 8 ,$$

wherein α indicates the inclination angle of the planet, P the pitch of the thread of the spindle and D its pitch circle diameter.

In this case, the following applies to the second, equally large group of planets:

$$α = ( {tan}^{- 1} ( P / ( π \cdot D ) ) ) / 2 \pm ( {tan}^{- 1} ( P / ( π \cdot D ) ) ) / 4 - ( {tan}^{- 1} ( P / ( π \cdot D ) ) ) / 8 ,$$

which implies that not all planets of the gearing have to be inclined to exactly the same degree.

The thread of the threaded spindle can be a single-start or a multi-start thread, in particular a two-start thread. The number of planets is typically between six and eighteen in various possible embodiments of the planetary roller gearing.

The method for producing the planetary roller gearing generally comprises the following steps, irrespective of the number of planets:
providing a threaded spindle, a number of elongated, stepped and rod-shaped planets with a groove-shaped profile as well as a drive assembly comprising two essentially annular planet carriers, wherein each planet carrier has a number of receptacles corresponding to the number of planets for mounting an end pin of a planet in each case,
providing a multi-part nut provided with groove-shaped profiled sections provided for contacting the planets and two rolling bearings, in particular in the form of ball or roller bearings, provided for mounting the nut in the drive assembly, and
inserting the planets, the nut and the rolling bearings into the drive assembly and concentrically arranging the threaded spindle in the drive assembly in such a way that each planet is inclined by an angle, which is at least 0.1° and at most 3.0°, by relative rotation between the two planet carriers relative to a plane in which the center of the respective planet and the central axis of the threaded spindle lie.

The relative rotation between the two planet carriers is maintained throughout the entire service life of the planetary roller gearing.

The planetary roller gearing is particularly suitable for use as a rotary linear gearing in a steering actuator of a motor vehicle. The steering actuator can basically be designed as an actuator for steering the rear wheels or as an actuator for steering the front wheels of the vehicle.

### BRIEF DESCRIPTION OF THE DRAWINGS

Several exemplary embodiments of the disclosure are explained in more detail below by means of drawings. In the figures:

FIG. 1 shows components of a planetary roller gearing used in an actuator of a rear axle steering system of a motor vehicle,

FIG. 2 shows the planetary roller gearing in a sectional view,

FIG. 3 shows the components of the planetary roller gearing in a front view,

FIG. 4 shows a detail of a planet carrier suitable for use in a planetary roller gearing for a steering actuator, and

FIG. 5 shows a planet carrier of the arrangement according to FIGS. 1 and 2 in a perspective view.

### DETAILED DESCRIPTION

Unless otherwise stated, the following explanations relate to all the exemplary embodiments. Parts that correspond to each other or have basically the same effect are denoted with the same reference signs in all the figures.

A planetary roller gearing 1 is provided for use in a steering actuator 10 of a rear axle steering system of a motor vehicle. With regard to the basic function of a planetary roller gearing in actuators of rear axle steering systems, reference is made to the prior art cited at the outset.

The planetary roller gearing 1 is used to displace a threaded spindle 2, the thread of which is designated with 3, in the transverse direction of the vehicle. The central axis of the threaded spindle 2 and thus of the entire planetary roller gearing 1 is designated with MA. End sections 4 of the threaded spindle 3 are articulated to other chassis elements, which are not shown, in order to vary the steering angle of the rear wheels of the motor vehicle in a manner known per se.

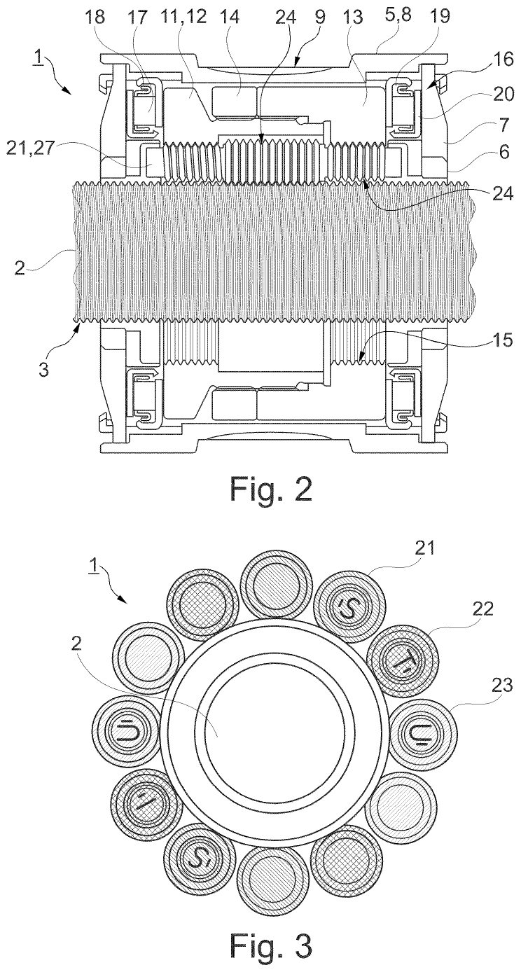

An input-side assembly of the planetary roller gearing 1 is collectively referred to as the drive assembly 5. The drive assembly 5 includes two planet carriers 6 essentially in the shape of an annular disc, two cage discs 7, also in the shape of an annular disc, and a sleeve 8. As can be seen from FIG. 2, the sleeve 8, which is concentric with the central axis MA, has a constriction on its outer circumferential surface in which an outer toothing 9 is formed. An electrically driven toothed belt runs over the outer toothing 9 as a component of a belt drive connected upstream of the planetary roller gearing 1. The shaft of the electric motor, which is not shown and drives the belt, is aligned in the z-direction, i.e., parallel to the central axis MA. The x-axis and the y-axis span a plane with respect to which the central axis MA represents a surface normal.

A cavity is formed between the threaded spindle 2 and the sleeve 8, in which further components of the planetary roller gearing 1 are arranged. These components include a nut 11, which comprises two nut parts 12, 13 screwed together and a lock nut 14. The nut parts 12, 13 each have a groove-shaped profiled section 15 (or threaded section). The entire nut 11, i.e., the spindle nut, is mounted in the drive assembly 5 by means of two rolling bearings 16, in this case axial rolling bearings. Each rolling bearing 16 has rollers as rolling elements 17, which are guided in a rolling bearing cage 18. The rolling elements 17 roll on an inner angle ring 19 and an outer angle ring 20, wherein the inner angle ring 19 contacts one of the two nut parts 12, 13 and the outer angle ring 20 contacts one of the cage discs 7 which are formed in a mirrored manner to each other.

Rod-shaped planets 21, 22, 23 of the first, second and third types, respectively, are furthermore arranged in the cavity surrounding the threaded spindle 2 in the drive assembly 5. Each planet 21, 22, 23 has groove-shaped, i.e., pitchless, profiled sections 24. Profiled sections 24 (or threaded sections) can be found both in a central piece 25 and in adjoining lateral pieces 26.

The lateral pieces 26 of the planets 21, 22, 23, like their central pieces 25, have a cylindrical basic shape, but exhibit a smaller diameter. The central piece 25 of each planet 21, 22, 23 exclusively contacts the thread 3 of the spindle 2, whereas the profiled sections 24 of the lateral pieces 26 mesh or threadedly engage exclusively with the profiled sections 15 (or threaded sections) of the nut 11. Towards the two end faces of each planet 21, 22, 23, it terminates in the form of an unprofiled end pin 27, which directly adjoins one of the two lateral pieces 26.

The end pins 27 are mounted in a sliding manner in receptacles 28 of the planet carriers 6. The various planets 21, 22, 23 differ from each other in that the profiled sections 24 (or threaded sections) of the central pieces 25 are slightly offset from each other in the axial direction, i.e., the z-direction, in order to adapt to the thread 3. In the present case, the thread 3 is designed as a two-start thread with a pitch P and a pitch diameter D, i.e., pitch circle diameter. The planets 21, 22, 23 are each inserted into the drive assembly 5 twice in a first orientation and twice in the opposite orientation, i.e., rotated by 180°. This means that there are a total of twelve planets 21, 22, 23 between the threaded spindle 2 and the nut 11.

The relationship between a certain rotation of the planet carrier 6 about the central axis MA and the resulting displacement of the threaded spindle 2 guided in a manner secured against rotation along the central axis MA is clearly defined, just as with a simple feed thread, which is synonymous with the pitch-accurate characteristic of the planetary roller gearing 1. The rolling of the planets 21, 22, 23 during operation of the planetary roller gearing 1 also causes the nut 11 to rotate, wherein this rotation is not utilized in any way. The rolling bearings 16 are merely used to transmit axial forces during operation of the planetary roller gearing 1.

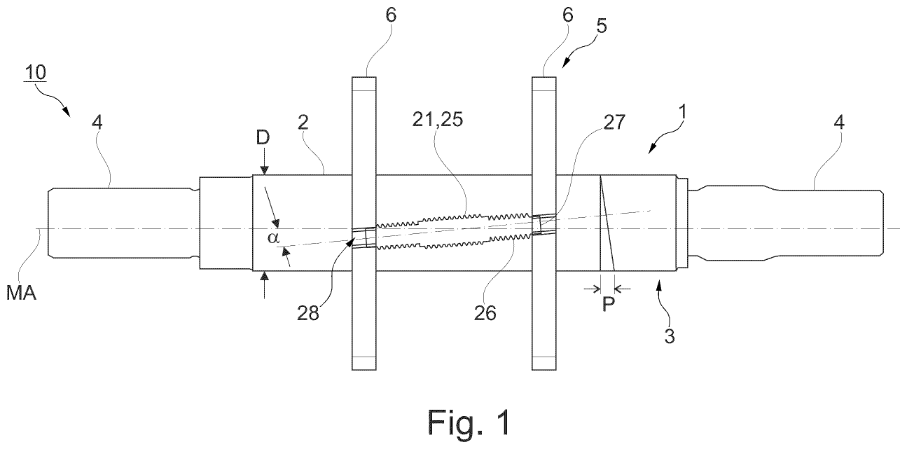

Axial forces are also transmitted between the central pieces 25 of the planets 21, 22, 23 and the threaded spindle 2. In order to optimize the interaction between the planets 21, 22, 23 and the thread 3, each planet 21, 22, 23 is inclined (or angularly mounted) by an angle α. The inclination refers to a plane in which both the central axis MA and the center of the respective planet 21, 22, 23 lie. If the angle α were zero, the longitudinal axis of the planet 21, 22, 23 would be aligned parallel to the central axis MA. The angle α is actually in the range between 0.5° and 1°. In FIG. 1, the angle α is shown in an exaggerated manner.

In the exemplary embodiment according to FIG. 1, the following relationship applies to those six planets 21, 22, 23 that are inserted into the drive assembly 5 in the first orientation:

$$α = ( {tan}^{- 1} ( P / ( π \cdot D ) ) ) / 2 \pm ( {tan}^{- 1} ( P / ( π \cdot D ) ) ) / 4 + ( {tan}^{- 1} ( P / ( π \cdot D ) ) ) / 8$$

The following applies to the other six planets 21, 22, 23, i.e., the planets 21, 22, 23 inserted into the drive assembly 5 in the opposite orientation:

$$α = ( {tan}^{- 1} ( P / ( π \cdot D ) ) ) / 2 \pm ( {tan}^{- 1} ( P / ( π \cdot D ) ) ) / 4 - ( {tan}^{- 1} ( P / ( π \cdot D ) ) ) / 8$$

The constraining of the planets 21, 22, 23 indicated by the angle α, which is accompanied by a relative rotation between the two planet carriers 6, contributes significantly to a uniform introduction of force into the two planet carriers 6 during operation of the planetary roller gearing 1. This implies that at least approximately the same torque, i.e., drive torque, acts on both planet carriers 6.

Just like the inclination angle α of the planet 21, the inclination of the receptacles 28 is also exaggerated in FIG. 1. As indicated in FIG. 5, there are two opposing groups of three receptacles 28 within the planet carrier 6, into which the planets 21, 22, 23 are to be inserted in a first orientation, and two opposing groups of three receptacles 28, into which the associated planets 21, 22, 23 are to be inserted in the opposite orientation. The orientation of the planets 21, 22, 23 can be determined visually by means of markings on one of the end faces of each planet 21, 22, 23, as shown in FIG. 3.

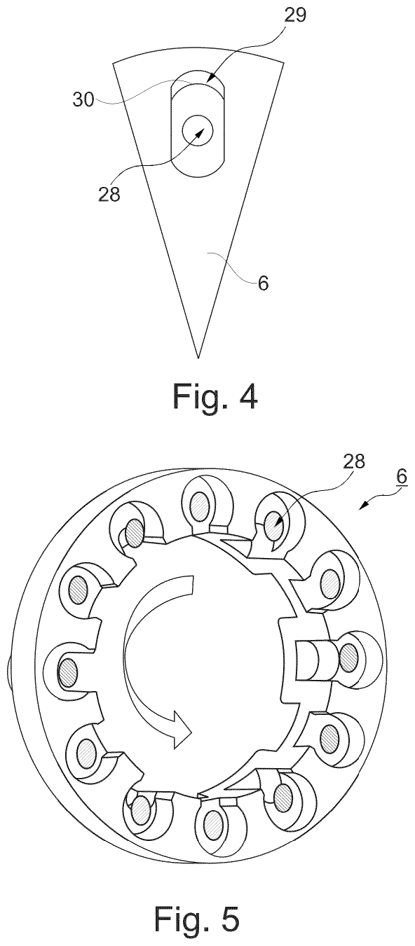

FIG. 4 shows a modification of a planet carrier 6 suitable for use in the planetary roller gearing 1 according to FIG. 1. In this case, the planet carrier 6 has a total of twelve elongated holes 29, in each of which a slide bushing 30 is guided in a displaceable manner to a limited extent in the radial direction of the planet carrier 6 and thus of the entire planetary roller gearing 1. In this case, the receptacle 28 for an end pin 27 of one of the planets 21, 22, 23 is formed by the slide bushing 30.

As in the case of FIG. 1, in the case of FIG. 4 the central axis of each receptacle 28 is also inclined by the angle α relative to a straight line which is parallel to the central axis MA of the threaded spindle 2. Due to the circular cross-sectional shape of the receptacles 28, which are formed as bores in the slide bushings 30, the conditions for the formation of a stable lubricating film between the end pin 27 and the receptacle 28 are particularly good compared to slot-shaped receptacles.

### LIST OF REFERENCE SYMBOLS

1 Planetary roller gearing
2 Threaded spindle
3 Thread
4 End section of the threaded spindle
5 Drive assembly
6 Planet carrier
7 Cage disc
8 Sleeve
9 Outer toothing
10 Steering actuator
11 Nut
12 Nut part
13 Nut part
14 Lock nut
15 Groove-shaped profiled section of the nut part
16 Rolling bearing
17 Rolling element, roller
18 Rolling bearing cage
19 Inner angle ring
20 Outer angle ring
21 Planet of the first type
22 Planet of the second type
23 Planet of the third type
24 Groove-shaped profiled section of the planets
25 Central piece
26 Lateral piece, profiled
27 End pin, not profiled
28 Receptacle for planets
29 Elongated hole
30 Slide bushing
α Angle
D Diameter
MA Central axis
P Pitch

1. A planetary roller gearing, comprising:
a drive assembly having:
a plurality of planets, each of the plurality of planets having a groove-shaped profiled section
a threaded spindle configured as an output element and engaged with central pieces of the plurality of planets, and
lateral pieces of the plurality of planets which have a groove-shaped profile and are thinner than the central pieces, mesh with profiled sections of a nut rotatably mounted in the drive assembly, and
two planet carriers supporting the plurality of planets such that a quantity of the plurality of planets are angularly mounted at a defined angle relative to a central axis of the threaded spindle.

2. The planetary roller gearing according to claim 1, wherein the two planet carriers have receptacles configured for a sliding bearing of non-profiled end pins of the quantity of the plurality of planets, and the receptacles are inclined to with respect to a plane applied to a corresponding one of the two planet carriers and normal to the central axis.

3. The planetary roller gearing according to claim 2, wherein the receptacles are formed by slide bushings integrated into the planet carriers, which can be displaced to a limited extent in a radial direction thereof.

4. The planetary roller gearing according to claim 1, wherein the quantity of the plurality of planets is inclined by an angle of at least 0.1° and at most 3.0°.

5. The planetary roller gearing according to claim 1, wherein the threaded spindle has a two-start thread.

6. The planetary roller gearing according to claim 1, a first quantity of the quantity of the plurality of planets divisible by two is mounted in the drive assembly according to the following equation:
$$α = ( {tan}^{- 1} ( P / ( π \cdot D ) ) ) / 2 \pm ( {tan}^{- 1} ( P / ( π \cdot D ) ) ) / 4 + ( {tan}^{- 1} ( P / ( π \cdot D ) ) ) / 8$$
and, a remaining quantity of the quantity of the plurality of planets divisible by two is mounted in the drive assembly according to the following equation:
$$α = ( {tan}^{- 1} ( P / ( π \cdot D ) ) ) / 2 \pm ( {tan}^{- 1} ( P / ( π \cdot D ) ) ) / 4 - ( {tan}^{- 1} ( P / ( π \cdot D ) ) ) / 8$$
wherein P corresponds to a pitch of a thread of the threaded spindle, and D corresponds to a pitch diameter of the thread of the threaded spindle.

7. The planetary roller gearing according to claim 1, further comprising two axial rolling bearings configured for mounting the nut in the drive assembly.

8. The planetary roller gearing according to claim 1, wherein the planet carriers are configured as plastic parts.

9. A method for producing a planetary roller gearing, comprising:
providing:
a threaded spindle,
a plurality of planets,
a drive assembly comprising two planet carriers, and each of the two planet carriers includes a plurality of receptacles corresponding to the plurality of planets for mounting an end pin of the plurality of planets,
a multi-part nut configured for contacting the planets, and
two rolling bearings configured for mounting the multi-part nut in the drive assembly,
inserting the plurality of planets, the multi-part nut and the two rolling bearings into the drive assembly and concentrically arranging the threaded spindle in the drive assembly such that at least one of the plurality of planets is angularly mounted according to an angle which is at least 0.1° and at most 3.0° relative to a central axis of the threaded spindle.

10. A steering actuator comprising an electrically driven planetary roller gearing according to claim 1.

11. The method according to claim 9, wherein the at least one of the plurality of planets is angularly mounted via: i) a first planet carrier that slidably receives a first end of the at least one of the plurality of planets, and ii) a second planet carrier that slidably receives a second end of the at least one of the plurality of planets.

12. The method according to claim 11, wherein the at least one of the plurality of planets is angularly mounted via: i) a first inclined receptacle disposed within the first planet carrier, and ii) a second inclined receptacle disposed within the second planet carrier.

13. A planetary roller gearing, comprising:
a plurality of planets, each of the plurality of planets having a groove-shaped profiled section,
a nut threadedly engaged with the plurality of planets via the groove-shaped profiled section,
a threaded spindle having a central axis, the threaded spindle threadedly engaged with the plurality of planets such that rotation of the plurality of planets and the nut about the threaded spindle causes linear movement of the threaded spindle along the central axis,
two planet carriers supporting ends of the plurality of planets such that a first quantity of the plurality of planets is supported at first inclined angle relative to the central axis via the two planet carriers, the two planet carriers configured to rotate about the threaded spindle.

14. The planetary roller gearing of claim 13, wherein a second quantity of the plurality of planets are supported at a second inclined angle relative to the central axis via the two planet carriers, the second inclined angle different than the first inclined angle.

15. The planetary roller gearing of claim 14, wherein the second quantity of the plurality of planets is arranged 180° from the first quantity of the plurality of planets.

16. The planetary roller gearing of claim 13, wherein the two planet carriers have receptacles that slidably receive non-profiled end pins of the first quantity of the plurality of planets, and the receptacles are inclined with respect to a plane applied to a corresponding one of the two planet carriers and normal to the central axis so as to support the first quantity of the plurality of planets at the first inclined angle.

17. The planetary roller gearing of claim 13, further comprising a sleeve arranged concentrically with the central axis, and the sleeve forms a cavity with the threaded spindle, and the nut and the plurality of planets are arranged within the cavity.

18. The planetary roller gearing of claim 17, wherein a first one of the two planet carriers is disposed at a first end of the sleeve, and a second one of the two planet carriers is disposed at a second end of the sleeve.

19. The planetary roller gearing of claim 18, further comprising:
a first rolling bearing arranged axially between the first one of the two planet carriers and the nut, and
a second rolling bearing arranged axially between the second one of the two planet carriers and the nut.

20. The planetary roller gearing of claim 13, further comprising a sleeve disposed around the nut, the sleeve having toothing formed on an outer circumference.
